(19) United States
(12) Patent Application Publication
(10) Pub. No.: US 2008/0163540 A1
(43) Pub. Date: Jul. 10, 2008

(54) Sliding sinker

(76) Inventor: Brian Ridolfi, Livermore, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/651,798

(22) Filed: Jan. 9, 2007

(51) Int. Cl. A01K 95/00; A01K 85/00

(52) U.S. Cl. 43/44.9; 43/42.36

(57) ABSTRACT

The invention broadly relates to an improvement in fishing line sinkers providing a simple and effective fishing line component that allows a user to easily attach and detach the sinker to and from the fishing line, while also allowing the sinker to slide freely along a portion of the line.

### BACKGROUND OF THE INVENTION

A. Field of the Invention

The invention broadly relates to an improvement in fishing line sinkers that provides a simple and effective fishing line component that allows a user to easily attach and detach the sinker to and from the fishing line, while also allowing the sinker to slide freely along a portion of the line.

B. Prior Art

This invention pertains to fishing weights, particularly sliding sinkers, that can slide freely along fishing line and can be attached to, and removed from, fishing line without any cutting, threading, or tying. The invention can be attached to fishing line so that baits or lures can sink within the water column. At the same time, the invention allows the line to slip through a central bore in the weight so that fish are not alerted to the presence of the weight. The invention can also be applied to anything with a central bore that allows the item to slide freely along fishing line, such as a glass bead. It is not uncommon for fishermen to routinely change equipment when faced with a lack of success. This is particularly the case in tournament fishing. Often, however, the materials that are used are difficult or time consuming to change.

Previous inventions have attempted to address these problems, but are inadequate. Some are impractical or complex, having machined parts like screws, too many movable parts that can separate from each other while in use, or do not slide freely along the line. Examples include U.S. Pat. Nos. 3,096,599; 3,273,278; 3,803,749; 5,157,860; 5,197,220; and 5,784,828.

Sliding sinkers are not new to the fishing world, and seasoned anglers are well aware of somewhat similar fishing devices. Sliding sinkers give weight to fishing rigs and can also slide freely along the line. Existing inventions that can be attached to and removed from fishing line, and that are characterized as sliding sinkers include U.S. Pat. Nos. 3,803,749; 5,157,860; and 5,784,828. However, these inventions are different in a variety of ways. For instance U.S. Pat. No. 5,784,828 requires rotation of a pivotally mounted hollow tube in the body before the fishing line can be locked in. U.S. Pat. Nos. 3,803,749 and 5,157,860 require sliding and inserting different pieces together so the pieces are frictionally locked in as one. All of these existing inventions contain detachable parts that are separable.

U.S. Pat. Nos. 3,096,599; 3,273,278; and 5,197,220 are designed to be easily attached to, and removed from, fishing line, but they do not operate exclusively as sliding sinkers. Like the previously cited prior references, these inventions are complex and have interchangeable parts for inserting onto the line like U.S. Pat. Nos. 3,096,599 and 5,197,220. U.S. Pat. No. 3,273,278 has a hollow rotatable tube for locking the fishing line to the device. Again, all these existing inventions have parts that can separate from one another.

The main objective of this invention is to provide to consumers a simple one-piece sliding sinker with no moving parts that can be attached to, and removed from, a fishing line without any cutting, threading, or tying.

The common problem with the aforementioned references is that they can become disassociated, or come apart, when they are in use. In the case of U.S. Pat. Nos. 3,096,599; 3,803,749; 5,157,860; and 5,197,220 the loss of a small piece of the assembly will eliminate the functionality of the whole product.

The present invention solves the problems in the prior art in new and novel ways. The invention will not disassociate while in use because it is a structure with no moving parts. Furthermore, the user will not be required to join together any parts. Further, the invention does not need to be threaded. A fisherman can simply open a package of these sliding sinkers and attach one to his or her fishing line without any tools and without combining pieces together. Another objective is to reduce the likelihood of the weight coming apart after the user casts it into the water and retrieves it. Many of the existing devices can accidentally release the weight from the fishing line due to their moving parts. Also, the invention described herein will allow the sinker to stay intact while casting and retrieving. In contrast to sliding sinkers that need threading, the invention described herein is easy to remove from the fishing line and will remain in one piece, making them very easy to store and organize.

### II. BRIEF SUMMARY OF THE INVENTION

The invention is an improvement in fishing line sinkers that provides a simple and effective fish line component constructed such that the user may easily attach and detach the sinker to and from the fishing line, while the sinker is allowed to slide freely along a portion of the fish line. In one embodiment, the device is lightweight and “bullet shaped”. However, a variety of different weights and other shapes like oval (egg shaped) are acceptable and included herein. Due to variability in fishing conditions, a variety of shapes and sizes of the invention can utilize elements of this invention.

The invention may comprise a weighted body, having an overall specific gravity greater than one, a longitudinal axial bore extending from the forward end portion to the rearward end portion, a radial slot for receiving fishing line extending from the bore to the outside of the body along the complete length of the bore, and a preferably straight hollow tube placed inside the bore having a radial slit extending along the entire length thereof. The radial slot along the outside of the body is preferably wider than the fishing line. The radial slit along the hollow tube within the bore is preferably narrower than the fishing line.

The weighted body is preferably homogeneous, and could be made from a variety of materials. When the user desires the device to be rigid, materials such as brass, tungsten, or iron can be used. When the user desires malleability, lead can be used. The interior hollow tube can be made from a variety of materials. However, it is preferably homogeneous and made of a non-rigid plastic.

### III. BRIEF DESCRIPTION OF THE DRAWINGS

FIG. 1 is a perspective view of an embodiment of the hollow inner tube.

FIG. 2 is a cross sectional top down view of an embodiment of the hollow inner tube.

FIG. 3 is a perspective view of an embodiment of the weighted body.

FIG. 4 is a cross sectional top down view of an embodiment of the weighted body.

FIG. 5 is a cross sectional top down view of an embodiment of the weighted body and hollow inner tube.

FIG. 6 is a perspective view of an embodiment of the weighted body and hollow inner tube shown with an attached fishing line and hook.

FIG. 7 is a perspective view of an embodiment of the hollow inner tube.

FIG. 8 is a cross sectional top down view of an embodiment of the hollow inner tube.

FIG. 9 is a perspective view of an embodiment of the weighted body.

FIG. 10 is a cross sectional top down view of an embodiment of the weighted body.

FIG. 11 is a cross sectional top down view of an embodiment of the weighted body and hollow inner tube in an open position.

FIG. 12 is a cross sectional top down view of an embodiment of the weighted body and hollow inner tube in a closed position.

### IV. DETAILED DESCRIPTION OF THE INVENTION

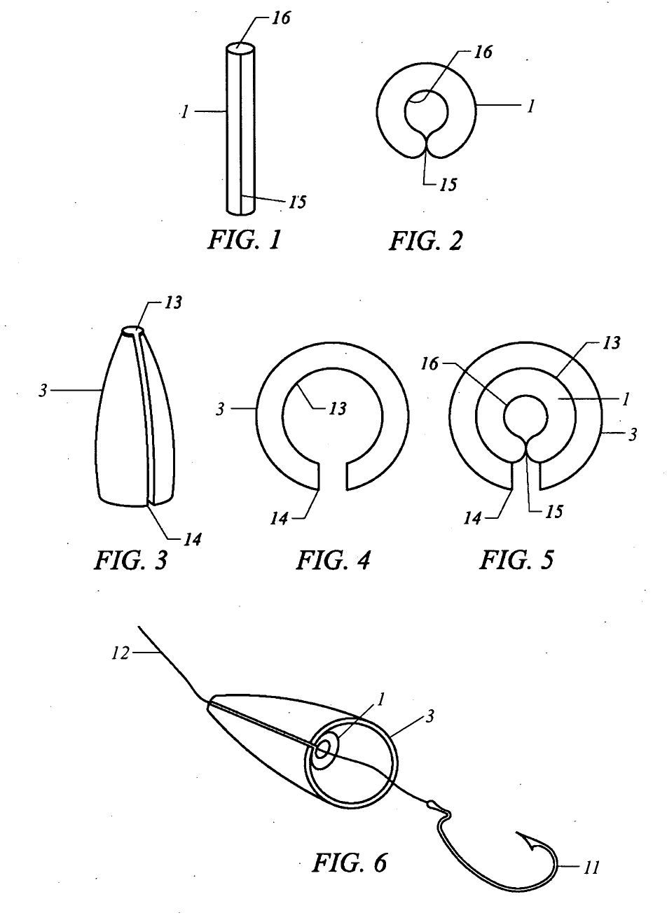

FIG. 1 is a perspective view of an embodiment of the hollow inner tube 1. The hollow inner tube 1 is preferably made of plastic, although other materials could be substituted, such as rubber, or any other appropriate substance. Preferably the inner tube 1 is made of a flexible, compressible type of plastic. The inner tube 1 has a smaller diameter than the bore 13 of the weighted body 3. The hollow inner tube 1 is intended to be permanently positioned inside the weighted body's bore 13. A variety of methods are available to affix the inner tube 1 inside the bore 13, including, but not limited to friction assisted containment force, or with an adhesive. Friction assisted containment force can occur when the frictional force between two objects sliding against one another is great enough to mitigate any force, such as gravity, that would allow the objects to slide and come apart.

The hollow inner tube 1 can be contained inside the bore 13 of the body 3 because there is just enough tolerance to allow the hollow inner tube 1 to seat inside the bore 13 and yet there is also enough compression exerted onto the walls of the inner tube 1 to stop it from moving independently from the bore 13. Like an object placed inside a vice grip, the hollow inner tube 1 will remain stationary if the tolerances are correct.

The hollow inner tube 1 is preferably homogeneous; however, a combination of materials could be used in its manufacture. The hollow inner tube 1 is also preferably cylindrical in shape and has a radial slit 15 extending along the entire length. It is intended that the edges of the radial slit 15 will either be in contact with each other, or sufficiently close to retain a fishing line that has been inserted into the tube. The gap between the edges of the radial slit 15, if any, should be narrow enough to retain standard fishing lines from 2 pound test and above.

The edges along the slit 15 of the hollow inner tube 1 are preferably rounded. This allows fishing line to pass through the slit 15, while at the same time preventing the fishing line 12 from fraying. It is intended that the user will insert the fishing line 12 through the slit 15, preferably by hand. The fishing line 12 will rest inside the inner tube's bore 16, and will not release until sufficient pulling force has be exerted on the fishing line 12 to pull it free. Under normal circumstances it is unlikely casting or retrieving the invention will provide sufficient force to pull the fishing line 12 through the narrow slit 15. However, pulling fishing line 12 through the narrow slit 15 by hand will separate the device from the fishing line 12. Tight tolerance prevents the slit 15 from opening up when the invention is being used, so significant pulling force may have to be applied to the fishing line 12 to pull it free from the bore 16.

FIG. 2 is a cross sectional top down view of an embodiment of the hollow inner tube 1. The figure shows the edges of the slit 15 are rounded, and in this drawing are in contact with each other. This is a preferred embodiment, since this will allow the user to pull or otherwise manipulate the fishing line 12 through the slit 15 and into the inner tube's bore 16 without breaking the line 12. Further, this configuration will allow the weight to slide easily along the fishing line during use. Also, the rounded edges 15 of the inner tube's bore 16 will allow the user to easily remove the fishing line 12 when desired without damaging the line 12.

FIG. 3 is a perspective view of an embodiment of the weighted body 3. The weighted body 3 has an axial bore 13, preferably longitudinal, that is larger in diameter than the hollow tube 1. This will allow the hollow tube 1 to be placed inside the axial bore 13 of the weighted body 3. The axial bore 13 in the weighted body 3 extends along the length of the weighted body 3 to house the hollow tube 1 and has an opening or slot 14 for receiving fishing line. The radial slot 14 extends from the bore 13 to the outside of the weighted body 3 along the complete length of the bore 13 and is preferably wider than the fishing line 12 so the line can pass easily into the bore 13.

The hollow tube 1 is preferably smaller in diameter than the bore 13 of the weighted body 3 and is contained inside the weighted body's bore 13 with a containment force or with an adhesive. The hollow tube 1 is preferably homogeneous, cylindrical in shape, and has a radial slit 15 extending along the entire length thereof.

FIG. 4 is a cross sectional top down view of an embodiment of the weighted body 3. As discussed above, the weighted body 3 has a bore 13 through its length. This bore 13 provides the space needed to position the hollow tube 1 within the weighted body 3. The opening or slot 14 allows the user to manipulate the fishing line 12 through the slot 14 and into the bore 13. The width of the slot 14 should be greater than the diameter of the fishing line 12 used.

FIG. 5 is a cross sectional top down view of an embodiment of the weighted body 3 and hollow inner tube 1. The radial slit 15 along the hollow tube 1 is preferably narrower than the fishing line 12. The hollow inner tube 1 is preferably made of plastic, particularly a compressible, flexible non-rigid plastic, (e.g. nylon). The ends of the radial slit 15 along the hollow tube 1 are preferably rounded. This allows fishing line 12 to pass through the slit 15 while preventing the fishing line 12 from fraying. Once the user manipulates the fishing line 12 through the narrow slit 15, preferably by hand, with sufficient pulling force, and the line rests inside the elongated plastic tube's bore 16, it is not anticipated that the fishing line will release until sufficient pulling force has been exerted on the line by the user to pull it free. Under normal circumstances it is unlikely casting or retrieving the device will provide sufficient force to pull the fishing line 12 through the narrow slit 15. Further, tight tolerance along the slit 15 prevents the slit 15 from disgorging the fishing line 12 when the device is being used.

FIG. 6 is a perspective view of an embodiment of the weighted body 3 and hollow inner tube 1 shown with an attached fishing line 12 and hook 11. When the hollow tube 1 is permanently inserted inside the bore 13 of the weighted body 3, the radial slot 14 and the radial slit 15 should be aligned. Once the hollow tube 1 and the weighted body 3 are combined together and aligned properly, the user can then pass the fishing line 12 through the radial slot 14 and radial slit 15. Because the hollow tube's bore 16 diameter is greater than the diameter of the fishing line 12, the invention can slide freely along the fishing line 12 without slipping off. The hook 11 or knotting structure along the fishing line 12 will prevent the device from sliding completely off of the fishing line 12.

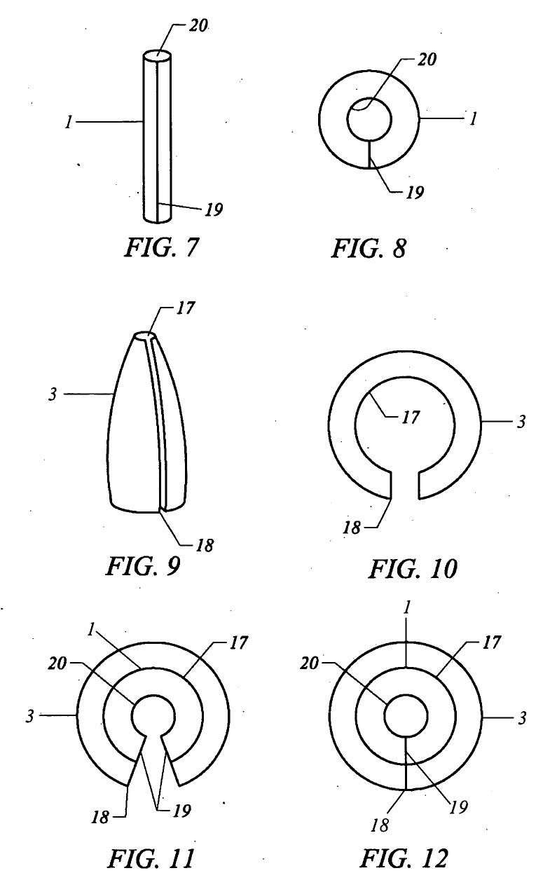

FIGS. 7-12 are perspective and cross sectional top down views of an alternative embodiment of the invention. These drawings illustrate a sliding split shot, wherein the weighted body 3 and the hollow tube 1 are malleable, such that both the slit 19 and the slot 18 are capable of being opened and closed by the user. The malleable materials used to make the components of this embodiment are preferably of a type that can remain submerged under water for prolonged periods without corroding or losing their malleability. The weighted body 3 can be made of lead, or other material that can perform in a similar manner. The weighted body 3 in this configuration is again preferably homogeneous, with a specific gravity greater than one. It is preferably bullet shaped for fishing plastic worms and grubs, but other shapes can be used depending on the conditions and the needs of the user.

FIGS. 7-12 show the weighted body 3 has a longitudinal axial bore 17 larger in diameter than the hollow inner tube 1. The longitudinal axial bore 17 extends along the length of the weighted body 3 and is capable of housing the hollow inner tube 1. Further, the axial bore 17 in the weighted body 3 has a slot 18 for receiving and removing fishing line 12. The radial slot 18 extends from the bore 17 to the outside of the weighted body 3 along the length of the bore 17. When compressed, the slot 18 in the weighted body 3 is narrower than the fishing line 12. In this configuration, it is intended that the slit 19 in the inner tube 1 and the slot 18 in the weighted body 3 can be opened and closed by the user.

The hollow inner tube 1 in FIGS. 7, 8, 11, and 12 is again smaller in diameter than the bore 17 of the weighted body 3 and is contained inside the weighted body's bore 17. The inner tube 1 can be affixed into the bore 17 in a variety of ways, such as compression force, adhesive, or other means. The hollow inner tube 1 is preferably, but not necessarily, homogeneous and cylindrical in shape. The hollow inner tube 1 has a radial slit 19 extending along the entire length thereof, and when compressed it is narrower than the fishing line 12. It is preferably made of plastic, particularly a flexible, compressible non-rigid type of plastic, such as, but not necessarily, nylon.

FIGS. 7, 8, and 12 show the hollow inner tube 1 in its closed position. FIGS. 9, 10, and 11 show the weighted body 3 in its open position. In this embodiment, the radial slit 19 and radial slot 18 can be pulled open by hand to allow fishing line 12 to pass through. Once the line is seated inside the bore 20 of the hollow inner tube 1, the radial slit 19 and radial slot 18 can be crimped closed, sealing the fishing line in the bore 20.

A difference between the invention described herein and a standard split shot is that the invention described herein can slide freely along fishing line during use, while a standard split shot stays stationary once it is crimped onto the line. Once the embodiment shown in FIGS. 7-12 is crimped onto the fishing line 12, the device functions in a similar manner to the embodiment shown in FIGS. 1-6.

When the hollow inner tube 1 of FIG. 7 and FIG. 8 is permanently inserted in the bore 17 of the weighted body 3, and the radial slot 18 and radial slit 19 are aligned as seen in FIG. 11 and FIG. 12, they will thereafter work as a single device. The user may then easily pass fishing line through the aligned radial slit 19 and radial slot 18 when in the open position and then seal in line by crimping the aligned radial slit 19 and radial slot 18 closed. Since the diameter of the bore 20 of the hollow inner tube 1 is greater than the diameter of the fishing line, the device can slide freely along the line without slipping off.

1-19. (canceled)

20. A weight for a fishing line comprising:
a. a weighted body;
b. the weighted body having an axial bore formed along a longitudinal central axis through the weighted body;
c. the weighted body having formed therein a radial slot extending along the entire length thereof and extending outward from the axial bore, the slot having two edges;
d. a hollow tube mounted in the axial bore of the weighted body;
e. the hollow tube having formed therein a radial slit extending along the entire length thereof;
f. wherein the radial slit in the hollow tube:
1. is permanently aligned with the radial slot of the weighted body;
2. has two edges, and wherein the edges are in contact with each other; and
3. is capable of receiving and retaining a fishing line; and
g. the weighted body and the hollow tube having an overall specific gravity greater than one.

21. A weight for a fishing line comprising:
a. a weighted body having an outer surface;
b. the body further having forward and rearward end portions in spaced-apart arrangement aligned along a longitudinal central axis;
c. the body having an axial bore formed therein passing there through interconnecting the forward and rearward end portions;
d. the body having formed therein a radial slot extending along the entire length thereof and extending outward from the central axis, the slot having two edges;
e. the weighted body is made from malleable materials, wherein the width of the slot in the body is capable of being manipulated by the user; and
f. the weighted body having an overall specific gravity greater than one.

22. The fishing line weight of claim 20, further comprising a hollow tube mounted in and concentrically aligned in the axial bore, terminated by first and second distal ends.

23. The fishing line weight of claim 22, wherein the hollow tube having formed therein a radial slit extending along the entire length thereof and extending outward from the central axis for receipt therein of the fishing line, the slit having a first edge and a second edge.

24. The fishing line weight of claim 23, further comprising a gap between the first and second edges of the hollow tube slit.

25. The fishing line weight of claim 24, wherein the gap between the first and second edges of the hollow tube slit is narrower than 1 millimeter.

26. The fishing line weight of claim 24, wherein the gap between the first and second edges of the hollow tube slit is between 1 and 4 millimeters.

27. The fishing line weight of claim 24, wherein the gap between the first and second edges of the hollow tube slit is greater than 4 millimeters.

28. The fishing line weight of claim 24, further comprising a gap between the edges of the slit in the hollow tube and gap between the edges of the slot in the weighted body.

29. The fishing line weight of claim 28, wherein the weighted body and the hollow tube are made from malleable materials, such that the gap between the edges of the slot in the weighted body and the gap between the edges of the slit in the hollow tube are capable of being manipulated by the user.

30. The fishing line weight of claim 20 or 22, wherein the hollow tube is made from plastic.

31. The fishing line weight of claim 20 or 21, wherein the weighted body is made from metal.

32. The fishing line weight of claim 20 or 21, wherein the weighted body is made from brass.

33. The fishing line weight of claim 20 or 21, wherein the weighted body is made from tungsten.

34. The fishing line weight of claim 20 or 21, wherein the weighted body is made from iron.

35. The fishing line weight of claim 20 or 21, wherein the weighted body is made from lead.

36. The fishing line weight of claim 20 or 21, further comprising a forward end portion and a rear end portion of the weighted body, wherein the forward end portion of the weighted body has a smaller circumference than the rear end portion of the weighted body.

37. The fishing line weight of claim 20 or 21, wherein the two edges of the slot in the weighted body are generally parallel.

38. The fishing line weight of claim 24, wherein the width of the gap in the slot in the weighted body is greater than the width of the slit in the hollow tube.

39. The fishing line weight of claim 22 wherein the edges of the slit in the hollow tube are rounded.

40. The fishing line weight of claim 24, wherein the gap between the edges of the slit in the hollow tube is narrower than the fishing line intended for use therein.

41. The fishing line weight of claim 20 or 21, wherein the two edges of the slot in the weighted body form an oblique angle to each other.
